(19) United States
(12) Patent Application Publication
(10) Pub. No.: US 2026/0263855 A1
(43) Pub. Date: Sep. 10, 2026

(54) FLUID RECIRCULATING FIRE SUPPRESSION DEVICE

(71) Applicant: Michael Warino, LaVerkin, UT (US)

(72) Inventor: Michael Warino, LaVerkin, UT (US)

(21) Appl. No.: 19/072,557

(22) Filed: Mar. 6, 2025

(51) Int. Cl. A62C 35/60; A62C 35/68

(52) U.S. Cl. CPC A62C 35/60; A62C 35/68

(57) ABSTRACT

A fluid recirculating fire suppression device includes a fluid reservoir containing an extinguishing fluid. A main pump positioned below a ground surface pumps the extinguishing fluid outwardly from the fluid reservoir to a plurality of vertically oriented stand pipes, each having a nozzle to spray the extinguishing fluid from the stand pipe. A control unit is in communication with the main pump to turn on the main pump when the control unit receives the actuate input. A drain is positioned proximate to the stand pipes to receive a portion of the extinguishing fluid sprayed through the nozzles and draining into the drain. A drain return pipe recirculates the portion of the extinguishing fluid to the fluid reservoir.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fire suppression devices and more particularly pertains to a new fire suppression device for recirculating fluid dispersed for fire suppression.

### (2) Description of Related Art Including Information Disclosed Under 37 CFR 1.97 and 1.98.

The prior art relates to fire suppression devices. Known fire suppression devices and systems lack reclaiming of fluids to enhance efficiency of fire suppression and both automated and remote control of operation of the device or system.

### BRIEF SUMMARY OF THE INVENTION

An embodiment of the disclosure meets the needs presented above by generally comprising a fluid reservoir containing an extinguishing fluid. A main pump positioned below a ground surface pumps the extinguishing fluid outwardly from the fluid reservoir to a plurality of vertically oriented stand pipes, each having a nozzle to spray the extinguishing fluid from the stand pipe. A control unit is in communication with the main pump to turn on the main pump when the control unit receives the actuate input. A drain is positioned proximate to the stand pipes to receive a portion of the extinguishing fluid sprayed through the nozzles and draining into the drain. A drain return pipe recirculates the portion of the extinguishing fluid to the fluid reservoir.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a fluid recirculating fire suppression device according to an embodiment of the disclosure.

FIG. 2 is a top detailed view of an embodiment of the disclosure of area 2 in FIG. 1.

FIG. 3 is a front view of an embodiment of the disclosure.

FIG. 4 is a detailed view of an embodiment of the disclosure of area 4 in FIG. 2.

FIG. 5 is a detailed view of an embodiment of the disclosure of area 5 in FIG. 1.

FIG. 6 is a front view of an embodiment of the disclosure.

FIG. 7 is a schematic view of an embodiment of the disclosure.

### DETAILED DESCRIPTION OF THE INVENTION

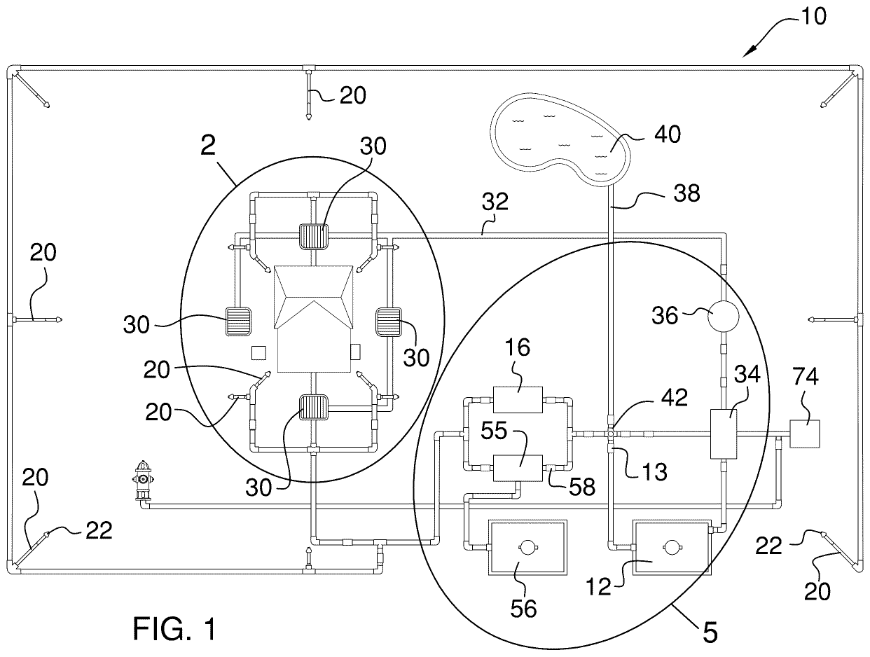

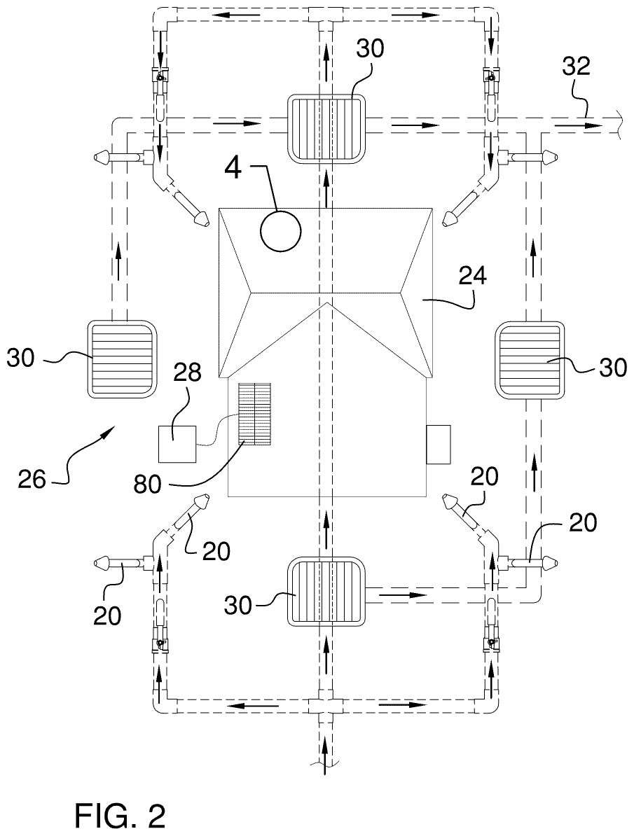

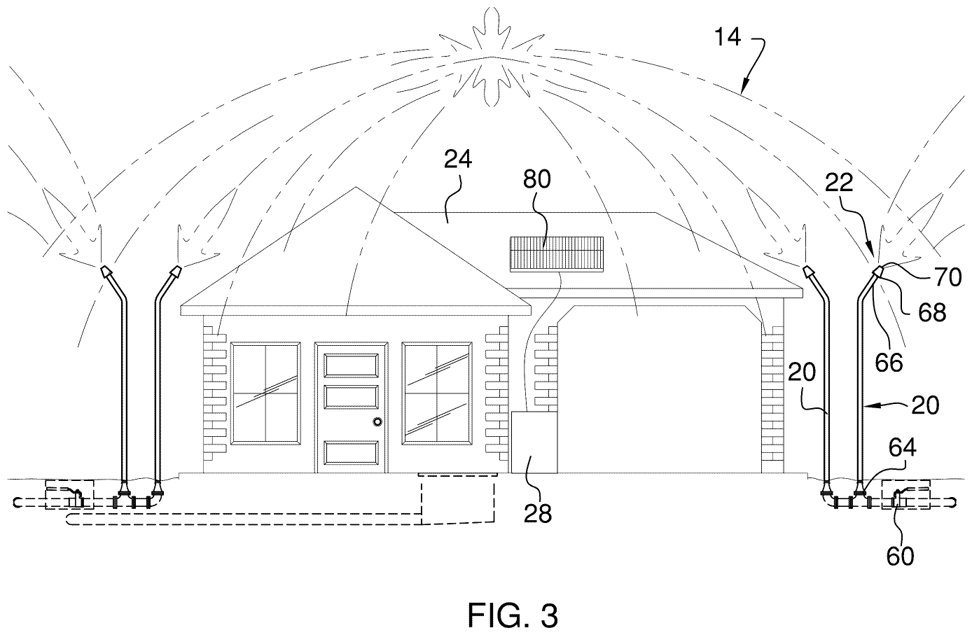

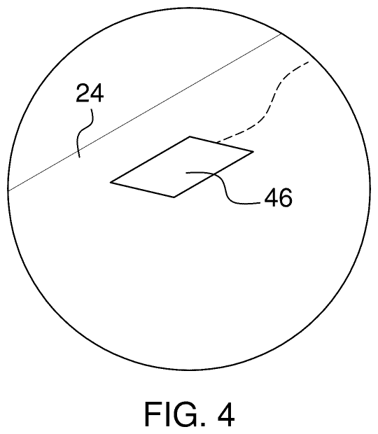

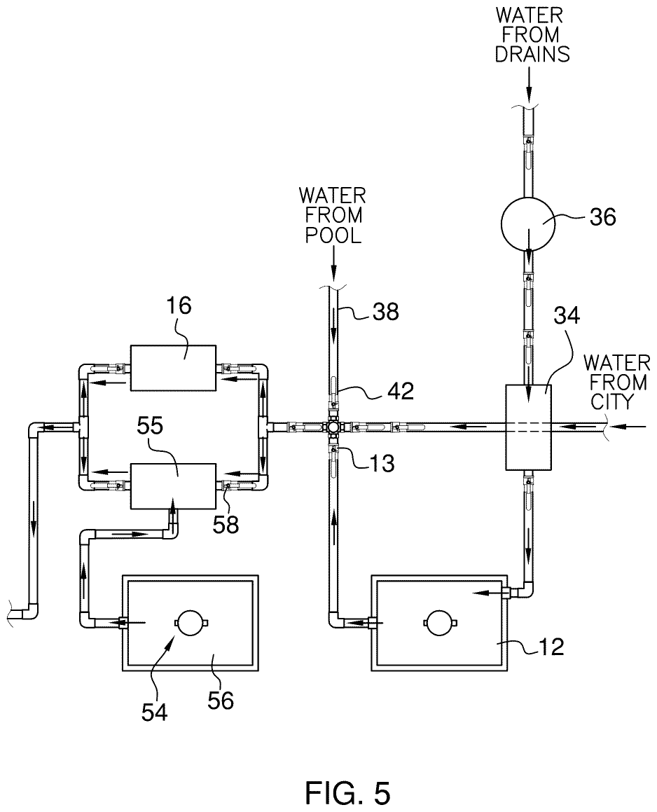

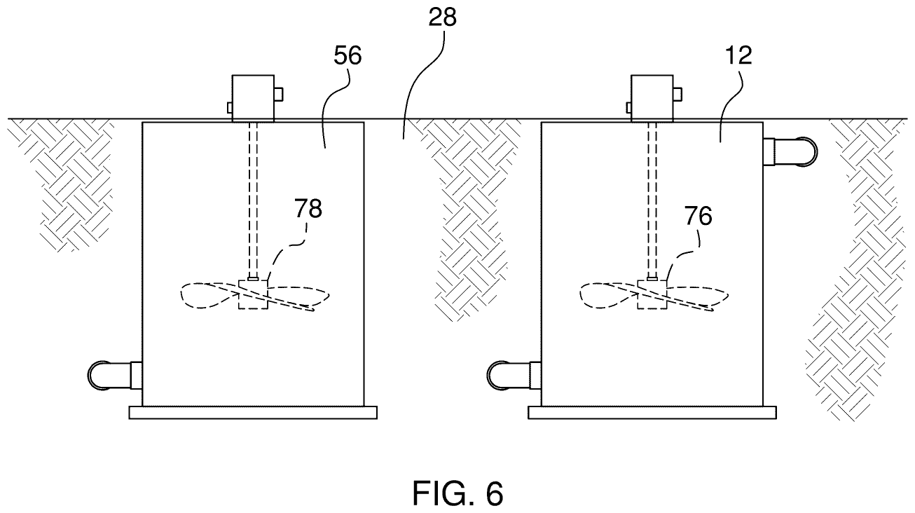

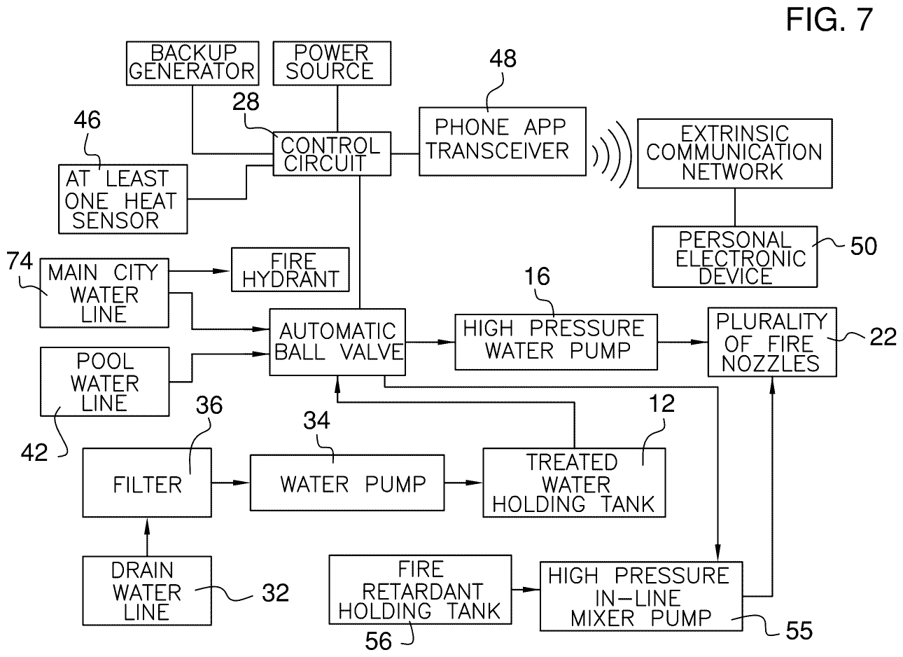

With reference now to the drawings, and in particular to FIGS. 1 through 7 thereof, a new fire suppression device embodying the principles and concepts of an embodiment of the disclosure and generally designated by the reference numeral 10 will be described.

As best illustrated in FIGS. 1 through 7, the fluid recirculating fire suppression device 10 generally comprises a fluid reservoir 12 containing an extinguishing fluid 14. A main pump 16 is positioned below a ground surface 18. The main pump 16 is in fluid communication with the fluid reservoir 12 facilitating the main pump 16 to urge the extinguishing fluid 14 outwardly from the fluid reservoir 12. Each of a plurality of stand pipes 20 is vertically oriented to extend from the ground surface 18. Each of the stand pipes 20 is in fluid communication with the main pump 16 such that each of the stand pipes 20 receives the extinguishing fluid 14 from the main pump 16. Each of a plurality of nozzles 22 is coupled to a respective one of the stand pipes 20 such that each of the nozzles 22 sprays the extinguishing fluid 14 outwardly from the nozzles 22. The stand pipes 20 and nozzles 22 are generally distributed around a structure 24 such as a house, business, or the like, and surrounding grounds 26 to be protected from fire. A control unit 28 in communication with the main pump 16. The control unit 28 receives an activation input to initiate the main pump 16 when the control unit 28 receives the activation input. The activation input may be manual or automated as described more fully below. A fluid reservoir shut off valve 13 may be used for shutting off fluid communication from the fluid reservoir 12 if desired.

The control unit 28 may be triggered by connection to a heat sensor 46. The heat sensor 46 may be one of an array of heat sensors 46 positioned to detect high heat associated with a fire. The heat sensor 46 is operationally coupled to the control unit 28 such that the control unit 28 activates the main pump 16 when the heat sensor 46 detects the high heat associated with the fire. The sensitivity of the heat sensors 46, or the trigger level upon which the main pump 16 is activated, may be adjustable including activation at levels which may be deemed conducive to a fire starting such that the structure 24 is effectively cooled or doused prior to the presence of a fire. The control unit 28 may be connected to a conventional power source such as electricity. A solar panel 80 may be electrically coupled to the control unit 28 to supplement power or provide power when conventional electricity sources are unavailable.

The control unit 28 may also be controlled manually and remotely. A receiver 48 is operationally coupled to the control unit 28. A remote device 50, such as a computer running software or a smartphone running an application, has a transmitter 52 for sending an activation signal or other communication with the control unit 28 for setting parameters of the operation as described below. The control unit 28 may activate the main pump 16 upon receiving the activation signal transmitted from the remote device 50.

A drain 30 is positioned proximate to the stand pipes 20 such that the drain 30 receives a portion of the extinguishing fluid 14 sprayed through the nozzles 22 and draining into the drain 30. A drain return pipe 32 is in fluid communication between the drain 30 and the fluid reservoir 12 to recirculate the portion of the extinguishing fluid 14 to the fluid reservoir 12 where it can be reused. A drain pump 34 is operationally coupled to the drain return pipe 32 for pumping the portion of extinguishing fluid 14 from the drain 30 to the fluid reservoir 12. A filter 36 is coupled between the drain 30 and the drain pump 34 for filtering debris from the portion of extinguishing fluid 14 pumped to the fluid reservoir 12.

In addition to the fluid reservoir 12, additional sources of fluid to combat a fire are incorporated into the device 10. A pool supply line 38 may fluidly couple a pool 40 to the main pump 16. A pool supply valve 42 is coupled to the pool supply line 38. The pool supply valve 42 is operationally coupled to the control unit 28 wherein the control unit 28 opens the pool supply valve 42 to supplement the extinguishing fluid 14 delivered to the main pump 16, or as a reserve to be used as additional fluid to be used upon emptying of the fluid reservoir 12.

The extinguishing fluid 14 may be water and a fire retardant fluid 54 may be stored in a fire retardant reservoir 56 used to supplement the extinguishing fluid 14. The fire retardant reservoir 56 is in fluid communication with the stand pipes 20 wherein the fire retardant fluid 54 is mixed with and sprayed out of the nozzles 22 when the main pump 16 is activated. A mixing pump 55 may be in fluid communication with the fire retardant reservoir 56. A fire retardant shut off valve 58 may be coupled between the fire retardant reservoir 56 and the stand pipes 20 such that fire retardant fluid 54 is prevented from being mixed with the extinguishing fluid 14 and sprayed out of the nozzles 22 when the fire retardant shut off valve 58 is closed. The fire retardant shut off valve 58 is operationally coupled to the control unit 28. Thus, application of the fire retardant fluid 54 may be controlled. The control unit 28 may be programmed to control the fire retardant fluid valve 58 automatically depending on conditions detected or known to be present. The conditions may be detected through the heat sensor 46, other sensors incorporated into the device 10 itself, or found through communication with sources extrinsic to the device 10 such as weather service warnings, emergency transmissions, or the like.

Additionally, for efficient usage of the extinguishing fluid 14, or other fluids and fire retardants consistent with this disclosure, each of a plurality of stand pipe shut off valves 60 is operationally coupled to an associated one of the stand pipes 20 wherein closure of each stand pipe shutoff valve 60 prevents pumping of the extinguishing fluid 14 through the associated one of the stand pipes 20. Each of the stand pipe shutoff valves 60 is operationally coupled to the control unit 28. Thus, based on input as to the conditions at a present time, delivery of the extinguishing fluid 14 may be directed to specific stand pipes 20 to most effectively and efficiently manage dispersing of the extinguishing fluid 14.

Each of the stand pipes 20 has a bottom end 64 and an upper end 66. Each of the stand pipes 20 penetrates the ground surface 18 having the bottom end 64 positioned below the ground surface 18. Each of the nozzles 22 has a coupled end 68 and a free end 70. The coupled end 68 of each of the nozzles 22 is fluidly coupled to the upper end 66 of each of the stand pipes 20. The free end 70 of each of the nozzles 22 is open thereby facilitating the free end 70 of each of the nozzles 22 to spray the extinguishing fluid 14 outwardly from the free end 70. Due to cost considerations it is likely the nozzles 22 would be fixed in how the extinguishing fluid is dispersed and the stand pipes 20 positioned for desired coverage. However, it is contemplated that additional control can be achieved through multifunctional nozzles 22 which may allow for control of spray patterns, spray pressure at the nozzle 22, and the like which may also be controlled through programming in the control unit 28 or manually through the remote device 50.

Additional sources of fluid to either fill the fluid reservoir 12, replace extinguishing fluid 14 in the fluid reservoir 12, are contemplated. A municipal or public water supply source 74 may be fluidly coupled to the fluid reservoir 12 and supply controlled by the control unit 28 using a dedicated valve and/or meter. The public water supply source 74 may be tied into the water sourcing for public fire hydrants. Additional fluid sources may be fluid connection to lakes, ponds, streams, or any other source of water available.

Each of the fluid reservoir 12 and the fire retardant reservoir 56 may incorporate a fluid agitator 76 and fire retardant agitator 78, respectively, to agitate within the fluid reservoir 12 and fire retardant reservoir 56 to break down sediment clumps or the like to inhibit clogging or malfunction of the nozzles 22.

In use, the control unit 28 activates the main pump 16 to disperse and control spraying of extinguishing fluid 14 with or without additional fire retardant fluid 54 either through automation programming or manual control through direct input or connection to the remote device 50. Using conventional internet connection, when available, the control unit can be operated from virtually anywhere.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fluid recirculating fire suppression device comprising:
a fluid reservoir containing an extinguishing fluid;
a main pump being positioned below a ground, said main pump being in fluid communication with said fluid reservoir thereby facilitating said main pump to urge said extinguishing fluid outwardly from said fluid reservoir;
a plurality of stand pipes, each of said stand pipes being vertically oriented, each of said stand pipes being in fluid communication with said main pump such that each of said stand pipes receives said extinguishing fluid from said main pump;
a plurality of nozzles, each of said nozzles being coupled to a respective one of said stand pipes such that each of said nozzles sprays said extinguishing fluid outwardly from said nozzles;
a control unit, said control unit being in communication with said main pump, said control unit receiving an actuate input, said main pump being turned on when said control unit receives said actuate input;
a drain, said drain being positioned proximate to said stand pipes wherein said drain is configured to receive a portion of the extinguishing fluid sprayed through said nozzles and draining into said drain;
a drain return pipe, said drain return pipe being in fluid communication between said drain and said fluid reservoir wherein said drain return pipe recirculates the portion of the extinguishing fluid to the fluid reservoir.

2. The device of claim 1, further comprising a drain pump operationally coupled to said drain return pipe for pumping the portion of extinguishing fluid from said drain to said fluid reservoir.

3. The device of claim 2, further comprising a filter coupled between said drain and said drain pump wherein said filter is configured for filtering debris from the portion of extinguishing fluid pumped to the fluid reservoir.

4. The device of claim 1, further comprising:
a pool;
a pool supply line fluidly coupling said pool to said main pump;
a pool supply valve coupled to said pool supply line, said pool supply valve being operationally coupled to said control unit wherein said control unit opens said pool supply valve to supplement the extinguishing fluid delivered to said main pump.

5. The device of claim 1, further comprising:
a heat sensor, said heat sensor being configured for positioning to detect high heat associated with a fire, said heat sensor being operationally coupled to said control unit wherein said control unit activates said main pump when said heat sensor detects the high heat associated with the fire.

6. The device of claim 1, further comprising:
a receiver operationally coupled to said control unit; and
a remote device, said remote device having a transmitter for sending an activation signal, said receiver activating said main pump upon receiving the activation signal transmitted from the remote device.

7. The device of claim 1, further comprising a fire retardant reservoir, a fire retardant fluid stored in said fire retardant reservoir, said fire retardant reservoir being in fluid communication with said stand pipes wherein said fire retardant fluid is mixed with and sprayed out of said nozzles when said main pump is activated.

8. The device of claim 7, further comprising a fire retardant shut off valve coupled between said fire retardant reservoir and said stand pipes wherein said fire retardant fluid is prevented from being sprayed out of said nozzles when said fire retardant shut off valve is closed.

9. The device of claim 8, further comprising said fire retardant shut off valve being operationally coupled to said control unit.

10. The device of claim 1, further comprising a plurality of stand pipe shut off valves, each of said stand pipe shutoff valves being operationally coupled to an associated one of said stand pipes wherein closure of each stand pipe shutoff valve prevents pumping of said extinguishing fluid through said associated one of said stand pipes.

11. The device of claim 10, further comprising each of the stand pipe shutoff valves being operationally coupled to said control unit.

12. The device of claim 2, wherein each of said stand pipes having a bottom end and an upper end, each of said stand pipes penetrating the ground having said bottom end being positioned below ground.

13. The device of claim 1, wherein:
each of said stand pipes has a bottom end and an upper end, each of said stand pipes penetrating the ground having said bottom end being positioned below ground; and
each of said nozzles has a coupled end and a free end, said coupled end of each of said nozzles being fluidly coupled to said upper end of each of said stand pipes, said free end of each of said nozzles being open thereby facilitating said free end of each of said nozzles to spray the extinguishing fluid outwardly from said free end.

14. The device of claim 1, further comprising a fluid agitator coupled to said fluid reservoir, said fluid agitator agitating the extinguishing fluid within the fluid reservoir when the fluid agitator is activated.

15. The device of claim 7, further comprising a fire retardant agitator coupled to said fire retardant reservoir, said fire retardant agitator agitating the fire retardant fluid within the fire retardant reservoir when the fire retardant agitator is activated.
